(19) United States
(12) Patent Application Publication
(10) Pub. No.: US 2008/0052390 A1
(43) Pub. Date: Feb. 28, 2008

(54) SYSTEM AND METHOD FOR VIRTUAL PRIVATE NETWORK ADDRESS PERSISTENCE

(75) Inventors: Douglas L. Jones, Raleigh, NC (US); Bryan D. Osenbach, Cary, NC (US)

Correspondence Address: CANTOR COLBURN LLP - IBM RSW, 20 Church Street, 22nd Floor, Hartford, CT, 06103, US

(73) Assignee: International Business Machines Corporation, Armonk, NY (US)

(21) Appl. No.: 11/467,729

(22) Filed: Aug. 28, 2006

(51) Int. Cl. G06F 15/173; H04L 12/56

(52) U.S. Cl. 709/224; 370/389

(57) ABSTRACT

A system for virtual private network (VPN) address persistence is provided. The system includes a VPN capable network device, wherein the network device further includes a VPN data monitor and a VPN queuing device. The system may also include a server, an enterprise firewall, and/or a gateway server, each with its own local VPN data monitor and VPN queuing device in accordance with embodiments of the present invention.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to computer networks and more particularly to virtual private networks (VPN).

2. Description of the Related Art

A connection manager such as IBM's Websphere Everyplace Connection Manager™ (WECM) provides seamless roaming capabilities that allows VPN users to change physical network addresses, switch network mediums, and undergo network outages, all without dropping VPN connections. This is performed by allowing the application to bind to the WECM Mobility Network Interface (MNI) in order for the network stack to use static source and destination addresses.

Examples using theoretical network addresses: hi a typical non-WECM environment, when a user is connected via TCP to IP address 4.3.2.1 and roams from IP address 1.2.3.4 to IP address 1.2.3.5, the TCP socket is lost and the stack is dropped thus breaking the application connection.

In a WECM environment, when a user initiates a connection to IP address 4.3.2.1 from IP address 1.2.3.4, the application binds the static client MNI address 192.168.1.1, and the connection is made from 192.168.1.1 to Gateway 32.32.32.1, and finally to address 4.3.2.1. Thus both the TCP endpoints always maintain a static address so the TCP socket is not lost and the network stack is not dropped in the event of a roam. When the user roams from physical address 1.2.3.4 to address 1.2.3.5, the roam is transparent in that the source of the packet will still be 192.168.1.1 and the destination 4.3.2.1.

The inherent problem with network outages or roaming is if the duration of a network outage or roam is longer than that of the maximum time-out of the application and/or protocol in use, the persistent connection is lost. For example, in the event of TCP, the time-out can be as little as a few seconds over a very fast network if the Round Trip Time (RTT) of each packet is a few milliseconds.

No known VPN solutions exist to mediate the problem.

Embodiments and aspects of the invention are described in detail herein and are considered a part of the claimed invention. For a better understanding of the invention with advantages and features, refer to the description and to the drawings.

### SUMMARY OF THE INVENTION

A key feature of the present embodiment is to inject a VPN monitor layer into the Open System Interconnection (OSI) layer to catch VPN traffic before it reaches the network layer in order to prevent persistent connections from timing out.

Within the realm of VPNs, in the event of a network outage an embodiment of the invention would inspect or monitor all existing connections to endpoints within the VPN network. Once a connection is identified, the embodiment would monitor for data from the application layer destined for the VPN network via the identified connection. If a network outage occurs briefly e.g, during a roam or the user is driving through a tunnel with a mobile device; and if the data matches the network or networks residing within the VPN network, the layer injected into the OSI model above the network stack would temporarily block the data from entering the network layer until network connectivity returns. As a result, the time-outs inherent in the network layer would be abstained and would enable true seamless roaming with connection persistence.

In accordance with one embodiment of the present invention a program storage device readable by a machine, tangibly embodying a program of instructions executable by the machine to perform a method for virtual private (VPN) persistence is provided. The method includes monitoring VPN-destined data from an application layer; determining if a VPN network is available; and queuing the monitored VPN-destined data from the application layer if the VPN network is not available.

The invention is also directed towards a system for virtual private network (VPN) address persistence. The system includes a VPN capable network device having VPN data monitor for monitoring VPN-destined data and a VPN queuing device for queuing the VPN-destined data.

### TECHNICAL EFFECTS

As a result of the summarized invention, technically we have achieved a solution which improves VPN roaming within a VPN network. Roaming is improved by way of maintaining a VPN connection to an endpoint during brief network unavailability.

In accordance with one embodiment of the invention, a program storage device readable by a machine, tangibly embodying a program of instructions executable by the machine to perform a method for virtual private (VPN) persistence is provided. The method includes monitoring VPN-destined data from an application layer; determining if a VPN network is available; and queuing the monitored VPN-destined data from the application layer if the VPN network is not available.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a pictorial diagram of a connected VPN network incorporating features of the present invention;

FIG. 1A is a graphical diagram of data flow in an open system interconnection (OSI) framework implementing features of the present invention shown in FIG. 1, when the VPN network is detected and corresponding physical links exist;

FIG. 1B is a graphical diagram of data flow in an internet protocol (IP) framework implementing features of the present invention shown in FIG. 1, when the VPN network is detected and corresponding physical links exist;

FIG. 2 is a pictorial diagram of a disconnected VPN network incorporating features of the present invention;

FIG. 2A is a graphical diagram of data flow in an open system interconnection (OSI) framework implementing features of the present invention shown in FIG. 1, when the VPN network is detected and corresponding physical links do not exist;

FIG. 2B is a graphical diagram of data flow in an internet protocol (IP) framework implementing features of the present invention shown in FIG. 1, when the VPN network is detected and corresponding physical links exist do not exist; and

FIG. 3 is a method flow chart showing one method maintaining VPN address persistence in accordance with FIG. 1, FIG. 1A, FIG. 1B, FIG. 2, FIG. 2A and FIG. 2B.

The detailed description explains the preferred embodiments of the invention, together with advantages and features, by way of example with reference to the drawings.

### DETAILED DESCRIPTION OF THE INVENTION

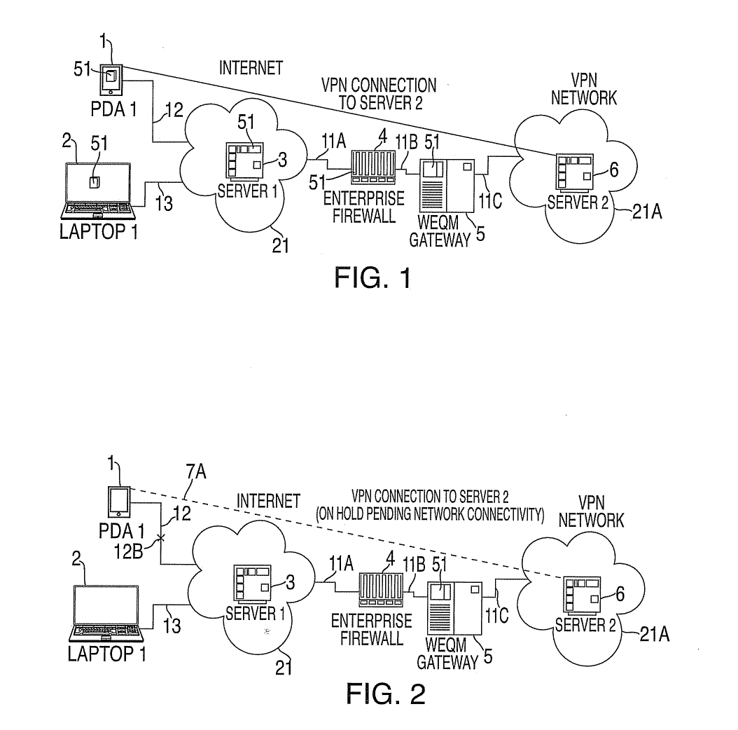

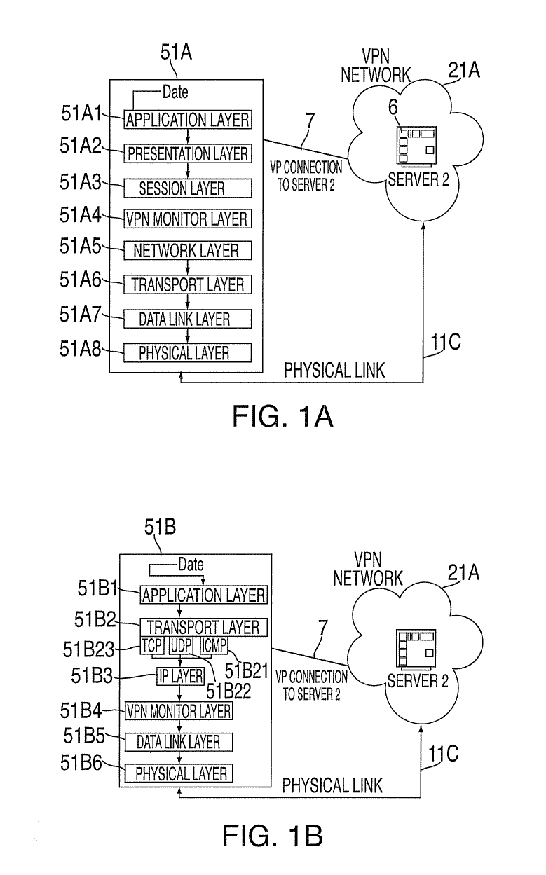

Turning now to FIG. 1, there is shown a pictorial diagram of a connected VPN network incorporating features of the present invention. Personal Data Assistant (PDA) 1 is connectable via connection line 12 to server 3 via Internet 21. It will be appreciated that connection line 12 may be any suitable connection such as wireless or wired. It will also be appreciated that Internet 21 contains any suitable resources and logic for establishing communications between PDA 1 and server 3. It will further appreciated that any suitable network capable device may be used.

Laptop 2 is connectable via connection line 13 to server 3 via Internet 21. It will be appreciated that connection line 12 may be any suitable connection such as wireless or wired. It will also be appreciated that Internet 21 contains any suitable resources and logic for establishing communications between PDA 1 and server 3.

Computer server 3 is connectable to enterprise firewall 4 via Internet 21 and connection line 11A. It will be appreciated that connection line 11A may be any suitable connection such as wireless or wired. It will also be appreciated that Internet 21 contains any suitable resources and logic for establishing communications between server 3 and enterprise firewall 4.

Enterprise firewall 4 is connectable via connection line 11B to gateway 5. It will be appreciated that connection line 11A may be any suitable connection such as wireless or wired. It will also be appreciated that gateway 5 may be any suitable gate way such as IBM's Websphere Everywhere Connection Manager™. Gateway 5 is connectable to end user server 2 via connection line 11C to Internet 21A. It will be understood that connection line 11C may be any suitable connection such as wireless or wired. It will also be understood that Internet 21A contains any suitable resources and logic for establishing communications between gateway 5 and server 2.

Still referring to FIG. 1, gateway 5 contains VPN data monitor and queuing device 51 in accordance with the present invention. It will be understood that VPN data monitor and queuing device may reside in any suitable VPN capable network device such as, but not limited to, the PDA 1, the laptop 2, server 3, or the enterprise firewall 4 as is shown in FIG. 1.

It will be appreciated by those skilled in the art that once a physical connection is made between PDA 1 and server 2, and/or between laptop 2 and server 2, then a virtual private network (VPNs) may exist.

It will also be understood by those skilled in the art that a VPN is a private network that uses a public network (usually the Internet) to connect remote sites or users together. Instead of using a dedicated, real-world connection such as leased line, a VPN uses “virtual” connections routed through the Internet from the company's private network to the remote site or employee.

There are two common types of VPN. The first, is Remote-access VPN. RA is also called a virtual private dial-up network (VPDN), and is a user-to-LAN connection used by a company that has employees who need to connect to the private network from various remote locations. Typically, a corporation that wishes to set up a large remote-access VPN will outsource to an enterprise service provider (ESP). The ESP sets up a network access server (NAS) and provides the remote users with desktop client software for their computers. The telecommuters can then dial a toll-free number to reach the NAS and use their VPN client software to access the corporate network.

The next type of VPN is site-to-site VPN. Through the use of dedicated equipment and large-scale encryption, a company can connect multiple fixed sites over a public network such as the Internet.

It will further appreciated by those skilled in the art that most VPNs rely on tunneling to create a private network that reaches across the Internet. In short, tunneling is the process of placing an encrypted data packet within another data packet and sending the hybrid data packet over a network. The protocol of the outer packet is understood by the network and both points, called tunnel interfaces, where the packet enters and exits the network. VPN tunneling is well known in art and will not be discussed here.

Turning also to FIG. 1A there is shown a graphical diagram of data flow in an open system interconnection (OSI) framework implementing features of the present invention shown in FIG. 1, when the VPN network is detected and corresponding physical links exists.

It will be appreciated that embodiments of the invention may be hosted by any appropriate network device. For example, referring still to FIG. 1, embodiments of the invention may reside in PDA 1, laptop 2, server 3, enterprise firewall 4, and/or WECM gateway 5. The following description describes the invention residing in the WECM gateway 5. It will be appreciated that any suitable gateway may be used.

Still referring to FIG. 1, VPN data is passed from application layer 51A1 to presentation layer 51A2. Application layer 51A1 supports application and end user processes. The layer provides application services for file transfers, email and other network services. Telnet and File Transfer Protocol are applications that exist entirely in the application level 51A1. The OSI application layer is well known in the art and need not be discussed further.

Presentation layer 51A2 provides independence from differences in data representation, for example, encryption, by translating from application to network format. This layer formats and encrypts data to be sent across a network.

Session layer 51A3 establishes, manages and terminates connections between applications.

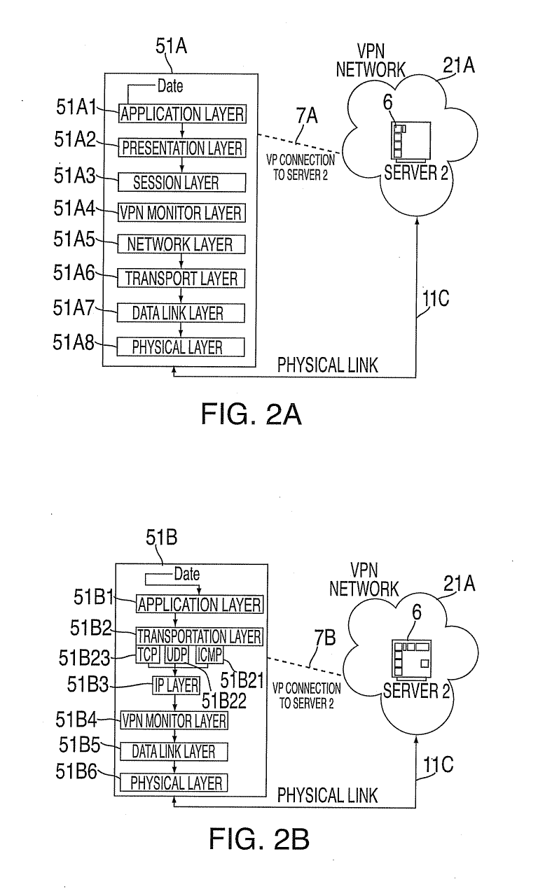

VPN monitor layer 51A4 inspects all existing persistent VPN connections to endpoints within the VPN network. Once a VPN network is identified 21A, the VPN monitor layer monitors data from the application layer 51A1 destined for the identified VPN network 21A via the VPN connection 7. If a physical connection is lost, (FIG. 2, item 12B) and if the VPN data matches the network or networks residing within the VPN network, the VPN monitor layer 51A4 temporarily halts or queues the VPN data before the data enters the network layer 51A5 until the physical connection is restored.

Network layer 51AB provides switching and routing logic and resources necessary for creating virtual circuits for transmitting data from node to node. Routing and forwarding are functions of this layer, as well as addressing and error handling. Thus, if the duration of a network outage or roam is longer than that of the maximum time-out of the application and protocol in use, the persistent VPN connection is lost. For example, in the event of a TCP protocol, the time-out can be as little as a few seconds over a very fast network if the Round Trip Time (RTT) of each data packet is a few milliseconds.

Transport layer 51A6, Data Link layer 51A7, and Physical layer 51A8 are well known in the art and need not be discussed further.

Referring now to FIG. 1B there is shown a graphical diagram of data flow in an internet protocol (IP) framework 51B implementing features of the present invention shown in FIG. 1, when the VPN network is detected and corresponding physical links exist.

As shown, data from the application layer 51B1 is first passed to a transport layer 51B2 consisting of several protocols used for various purposes. The TCP portion 51B23 of the transport layer organizes data into packets and provides reliable packet delivery across a network through the IP layer 51B3. (TCP is said to be “connection oriented” in that TCP checks to see if the data arrived at its destination and will re-send if it did not.) UDP 51B222 or User Datagram Protocol also moves data to the IP layer 51B3, but unlike TCP 51B23 does not guarantee reliable packet delivery. Lastly, the Internet Control Message Protocol or ICMP 51B21 is used to report network errors and if a computer is available on the network.

From the transport layer 51B2 data is passed to the Internet Protocol (IP) Layer 51B3 responsible for delivering TCP 51B23 and UDP 51B22 packets across a network. IP 51B3 transfers the data packets to the data link 51B5 and physical layer 51B6, i.e., network interface card (NIC) through VPN monitor layer 51B4.

VPN monitor layer 51B4 operates similarly to the earlier described VPN monitor layer 51A4 in the OSI network model. VPN monitor layer 51B4 inspects all existing persistent VPN connections to endpoints within the VPN network. Once a VPN network is identified 21A, the VPN monitor layer 51B4 monitors data from the application layer 51B1 destined for the identified VPN network 21A via the VPN connection 7. If a physical connection is lost, (FIG. 2, item 12B) and if the VPN data matches the network or networks residing within the VPN network, the VPN monitor layer 51B4 temporarily halts or queues the VPN data before the data enters the IP layer 51B3 until the physical connection is restored.

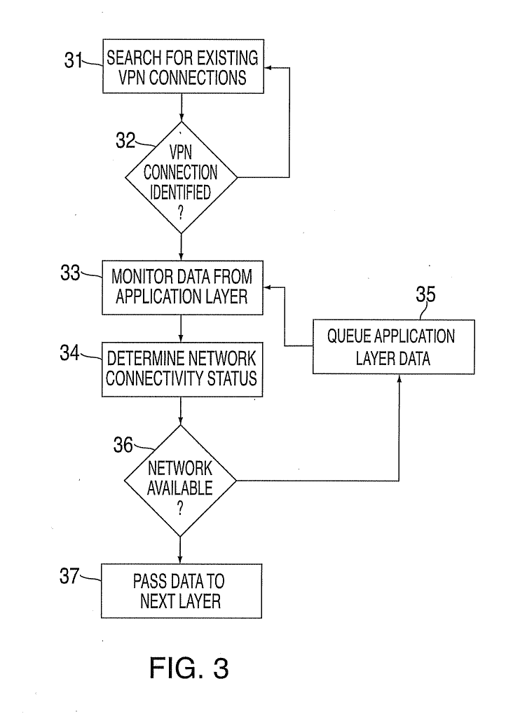

Turning also to FIG. 3 there is shown a method flow chart showing one method maintaining VPN address persistence in accordance with FIG. 1, FIG. 1A, FIG. 1B, FIG. 2, FIG. 2A and FIG. 2B. An embodiment of the invention would inspect all existing connections to endpoints within the VPN network 31. Once a connection is identified 32, the embodiment would monitor 33 for data packets from the application layer destined for the VPN network via the identified connection. An embodiment of the present invention would also monitor the VPN network for availability 34. If the VPN network is determined available 35 the invention embodiment allows or passes the data packets through to the network level. It will be understood that once a data packet enters the network level the data packet has a discrete time-to-live (TTL) or hop-time before which the data packet must reach its destination before an error is declared.

If a network outage occurs, e.g., during a roam or driving through a tunnel with a mobile device and if an embodiment of the present invention determines the VPN network is not available 34 and if the data matches the network or networks residing within the VPN network, the layer injected into the OSI model above the network stack would temporarily queue 35 the traffic from entering the network layer until network connectivity returns.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The diagrams depicted herein are just examples. There may be many variations to these diagrams described therein without departing from the spirit of the invention. The flow diagrams depicted herein are also just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. For example, any suitable IP protocol may be used. Such as, for example, Ipv4 or Ipv6. In addition, the previously described WECM or any suitable connection manager may be used. These claims should be construed to maintain the proper protection for the invention first described.

What is claimed is:

1. A program storage device readable by a machine, tangibly embodying a program of instructions executable by the machine to perform a method for virtual private (VPN) persistence, the method comprising:
monitoring VPN-destined data from an application layer;
determining if a VPN network is available; and
queuing the monitored VPN-destined data from the application layer if the VPN network is not available.

2. The program storage device readable by a machine, tangibly embodying a program of instructions executable by the machine to perform a method for virtual private (VPN) persistence as in claim 1, wherein determining if the VPN network is available comprises:
determining a static client address; and
monitoring network connectivity between an interface address and the static client address.

3. The program storage device readable by a machine, tangibly embodying a program of instructions executable by the machine to perform a method for virtual private (VPN) persistence as in claim 2, wherein monitoring network connectivity between an interface address and the static client address further comprises
determining a gateway address; and
monitoring network connectivity between the interface address and the gateway address.

4. The program storage device readable by a machine, tangibly embodying a program of instructions executable by the machine to perform a method for virtual private (VPN) persistence as in claim 2, wherein monitoring network connectivity between an interface address and the static client address further comprises
determining an endpoint address; and
monitoring network connectivity between the endpoint address and the gateway address.

5. The program storage device readable by a machine, tangibly embodying a program of instructions executable by the machine to perform a method for virtual private (VPN) persistence as in claim 1, wherein monitoring VPN-destined data from the application layer comprises monitoring discrete VPN-destined data packets.

6. The program storage device readable by a machine, tangibly embodying a program of instructions executable by the machine to perform a method for virtual private (VPN) persistence as in claim 5, wherein queuing the monitored VPN-destined data from the application layer if the VPN network is not available further comprises queuing at least one of the discrete VPN-destined packets.

7. A system for virtual private network (VPN) address persistence, the system comprising:
a VPN capable network device, wherein the network device comprises:
a VPN data monitor; and
a VPN queuing device.

8. The system as in claim 7 further comprising a VPN capable server connectible to the VPN capable network device, wherein the VPN capable server comprises:
a server VPN data monitor; and
a server VPN queuing device.

9. The system as in claim 8 further comprising a VPN capable enterprise firewall connectible to the VPN capable server, wherein the VPN capable server comprises:
an enterprise VPN data monitor; and
an enterprise VPN queuing device.

10. The system as in claim 9 further comprising a VPN capable gateway connectible to the VPN capable enterprise sever, wherein the VPN capable gateway comprises:
a gateway VPN data monitor; and
a gateway VPN queuing device.

11. The system as in claim 10 wherein the VPN capable gateway comprises a Web Everywhere Connection Manager™ (WECM).

12. The system as in claim 7 wherein the VPN capable network device further comprises a remote access VPN device.

13. The system as in claim 12 wherein the remote access VPN device further comprises a Personal Data Assistant (PDA).

14. The system as in claim 7 wherein the VPN capable network device further comprises a site-to-site VPN device.

15. A method for virtual private network (VPN) address persistence, the method comprising:
monitoring VPN-destined data from an application layer, wherein monitoring VPN-destined data from the application layer comprises monitoring discrete VPN-destined data packets;
determining if a VPN network is available, wherein determining if the VPN network is available comprises:
determining a static client address;
monitoring network connectivity between an interface address and the static client address, wherein monitoring network connectivity between an interface address and the static client address further comprises:
determining a gateway address;
monitoring network connectivity between the interface address and the gateway address; and
queuing the monitored VPN-destined data from the application layer if the VPN network is not available, wherein queuing the monitored VPN-destined data from the application layer if the VPN network is not available further comprises queuing at least one of the discrete VPN-destined packets.
